(19) United States
(12) Patent Application Publication
(10) Pub. No.: US 2008/0155097 A1
(43) Pub. Date: Jun. 26, 2008

(54) CENTRALIZED PROCESSING SYSTEM FOR CONNECT HOMES DEVICES

(75) Inventor: Chiew Seng Sean Tan, Singapore (SG)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/614,123

(22) Filed: Dec. 21, 2006

(51) Int. Cl. G06F 15/173

(52) U.S. Cl. 709/225

(57) ABSTRACT

At least one request for a service (504) is received at a central processing system (104) from at least one thin client home device (106). Processing required to support the requested service is determined (615) based on the at least one request. At least one local processor is selected (617) from a set of local processors, in response to determining that the processing can be provided locally, to perform the processing based upon the processing required to support the service. In response to determining that the service cannot be provided locally, a remote service provider associated with the requested service is identified and data for the service from the remote service provider is requested (618). The processed data is transmitted over the network (102) to the at least one thin client home device (106).

### FIELD OF THE INVENTION

The present invention generally relates to the field of centralized processing systems, and more particularly relates to providing a centralized processing system for home devices.

### BACKGROUND OF THE INVENTION

Technology has progressed to such a state that many home users are able to have various multimedia and network devices. For example, a home user can have a set-top box, an Internet Protocol Television (IPTV) device, videophone, access points, and the like. Each of these devices is typically independent of one another. For example, each device comprises its own processor for processing audio and video and includes its own memory system. Although independent of one another, each of these devices can include common components. For example, many of the home devices include audio and video codec processors. Because a networking infrastructure does not exist for connecting each of these devices, each device has to use its own resources even though another device may have available resources. Furthermore, a device is constrained by its own memory system when performing processing tasks

With embedded components (hardware includes CPU, wireless module, Flash ROM, SDRAM and the like, software includes OS, firmware, drivers and the like) in the present home devices, they will be technologically incompatible and rendered obsolete with the introduction of newly available technologies and specifications. There will be a need to have the home devices replaced completely after some time. The processing capabilities are limited and are expensive to be replaced.

Therefore a need exists to overcome the problems with the prior art as discussed above.

### SUMMARY OF THE INVENTION

Briefly, in accordance with the present invention, disclosed are a method, information processing system, and computing environment for providing services to a thin client home device. The method includes receiving, from at least one thin client home device, at least one request for a service. Processing required to support the service requested by the at least one thin client home device is determined based on the at least one request. The method also includes determining that the processing can be provided locally. At least one local processor from a set of local processors is selected perform the processing based upon the processing required to support the service in response to determining that the processing can be provided locally. The following is performed in response to determining that the service cannot be provided locally. A remote service provider associated with the requested service is identified. Data for the service is requested from the remote service provider. At least one remote processor from a set of remote processors is selected, in response to determining that the processing cannot be provided locally, to perform the processing based upon the processing required to support the service and to process the data to produce processed data. The processed data is transmitted to the at least one thin client home device.

In another embodiment an information processing system for providing services to a thin client home device is disclosed. The information processing system comprises a memory and a processor that is communicatively coupled to the memory. The information processing system also includes a home client device management module that is communicatively coupled to the memory and the processor. The home client device management module is for receiving, from at least one thin client home device, at least one request for a service. Processing required to support the service requested by the at least one thin client home device is determined based on the at least one request. The home client device management module also determines that the processing can be provided locally. At least one local processor from a set of local processors is selected perform the processing based upon the processing required to support the service in response to determining that the processing can be provided locally. The following is performed by the home client device management module in response to determining that the service cannot be provided locally. A remote service provider associated with the requested service is identified. Data for the service is requested from the remote service provider. At least one remote processor from a set of remote processors is selected, in response to determining that the processing cannot be provided locally, to perform the processing based upon the processing required to support the service and to process the data to produce processed data. The processed data is transmitted to the at least one thin client home device.

In yet another embodiment, a computing environment for providing services to a thin client home device is disclosed. The computing environment includes at least one thin client home device and a centralized processing system that is communicatively coupled to the thin client home device. The centralized processing system includes a home client device management module that is for receiving, from at least one thin client home device, at least one request for a service. Processing required to support the service requested by the at least one thin client home device is determined based on the at least one request. The home client device management module also determines that the processing can be provided locally. At least one local processor from a set of local processors is selected perform the processing based upon the processing required to support the service in response to determining that the processing can be provided locally. The following is performed by the home client device management module in response to determining that the service cannot be provided locally. A remote service provider associated with the requested service is identified. Data for the service is requested from the remote service provider. At least one remote processor from a set of remote processors is selected, in response to determining that the processing cannot be provided locally, to perform the processing based upon the processing required to support the service and to process the data to produce processed data. The processed data is transmitted to the at least one thin client home device.

One advantage of the present invention is that a centralized processing system is provided for managing a network of home devices. The central processing system provides a network infrastructure that interconnects home devices. Common components such as audio/video processing resources, memory systems, and the like are included within the centralized processing system and shared by the interconnected home devices. For example, the centralized processing system provides a scalable processing blade that can replace the embedded processor of the home devices. Therefore, the redundant resources of the home devices can be centrally located and managed by a single system, thereby providing efficient allocation and usage of available resources by multiple devices being served by the central processing system.

Another advantage of the present invention is that both the hardware and software capabilities of the interconnected home client devices can be enhanced, as needed. This removes any performance limitation and increases the user experience. Another advantage of the present invention is the centralized processing system allows Plug-and-Play and automatic configuration using the identifier manager to ensure that resources are guaranteed for all successfully authenticated home client devices. Yet another advantage of the present invention is the ease of maintaining the centralized processing system and its interconnected home devices. Replacement, addition, and maintenance of hardware components (such as processing blade, memory, new server and the like) are performed at a central location. The central location could be inside the home premise or in another remote location.]

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating an exemplary network according to an embodiment of the present invention;

FIG. 2 is a block diagram of a general system architecture for the central processing system of FIG. 1 according to an embodiment of the present invention;

FIG. 3 is a more detailed view of the home client devices of FIG. 1 according to one embodiment of the present invention;

FIG. 4 is a detailed view of the central processing system of FIG. 1 according to an embodiment of the present invention;

FIG. 5 is an operational flow diagram illustrating an exemplary process of a home device requesting content/services from a central processing system according to an embodiment of the present invention;

FIG. 6 is an operational flow diagram illustrating an exemplary process of a central processing system providing requested content/services to one or more home client devices according to an embodiment of the present invention; and

FIG. 7 is a detailed operational flow diagram illustrating an exemplary process for providing requested content/services to one or more home client devices according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Exemplary Network

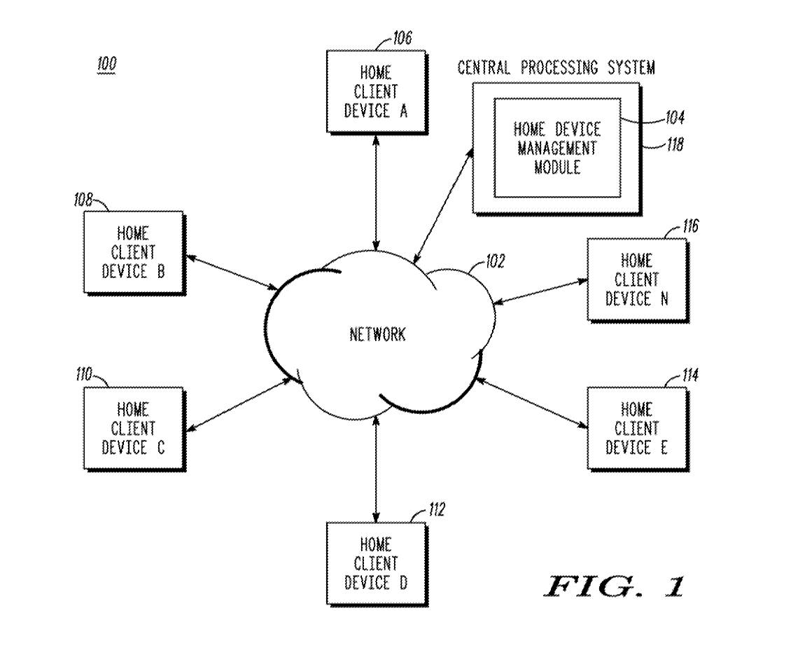

According to an embodiment of the present invention, as shown in FIG. 1, an exemplary network 100 is illustrated. FIG. 1 shows a network 102 that communicatively couples a centralized processing system 104 to a plurality of home client devices 106, 108, 110, 112, 114, 116. A home client device, in one embodiment, is any device capable of processing audio/video and/or accessing a wide area network such as the Internet. A home client device, in one embodiment, is also any device used to facilitate communications (voice, video, data, commands and the like) in one-way, two-way, and interactive mode of transmission or exchange of information. The communication of the home client device is not limited to human-to-device, but also device-to-device. The central processing system 104, in one embodiment, is an information processing system that manages the interconnected home client devices and provides resources such as processing functions to the home client devices. In one embodiment, the central processing system 104 includes a home client device management module 118. The central processing system 104 and the home client device management module 118 are discussed in greater detail below.

The network 102, in one embodiment, can either be wired or wireless. For example, the network 102 can comprise TCP based network such as a Gigabyte Ethernet network or the like. The network 102 can also comprise a wireless network such as an 802.11 network, 802.16 network, or the like. Additionally, the network 102 can also be part of a wireless communications network. The communications standard of a wireless communications network can comprise Code Division Multiple Access (CDMA), Time Division Multiple Access (TDMA), Global System for Mobile Communications (GSM), General Packet Radio Service (GPRS), Frequency Division Multiple Access (FDMA), IEEE 802.16 family of standards, Orthogonal Frequency Division Multiplexing (OFDM), Orthogonal Frequency Division Multiple Access (OFDMA), or the like.

In this example, wireless communication devices (not shown) may also be included with the network system 100. For example, as discussed above, the network 102 can include an 802.16 network. This type of network provides a high bandwidth connection to its connected devices. Each of the home client devices can include a wireless interface card (not shown) that allows them to connect to the 802.16 network. The central processing system 104, in this example, can be a central server that manages wireless connections for a wireless communication systems. When a user brings her wireless communication device into her house, the wireless communication device can switch from, for example, a CDMA mode to an 802.16 mode. The wireless communication device is then able to communicate with the home client devices and the central processing system for receiving audio, video, and the like. A wireless communication a mobile telephone, smart phone, text messaging device, handheld computer, pager, beeper, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

In one embodiment, the home client devices are “thin client” home client device. A thin-client home device, in one embodiment, is a home client device comprising only the necessary components for receiving a user's input request, displaying output to a user, and exchanging data with the central processing system 104. For example, functions such as network path management, application data exchange, audio/video processing, audio/video recording, end to end data connections, and the like are not required to reside on the home client device. Instead, the central processing system 104 can perform these functions for the home client device. The home client devices are discussed in greater detail below.

Information Processing System

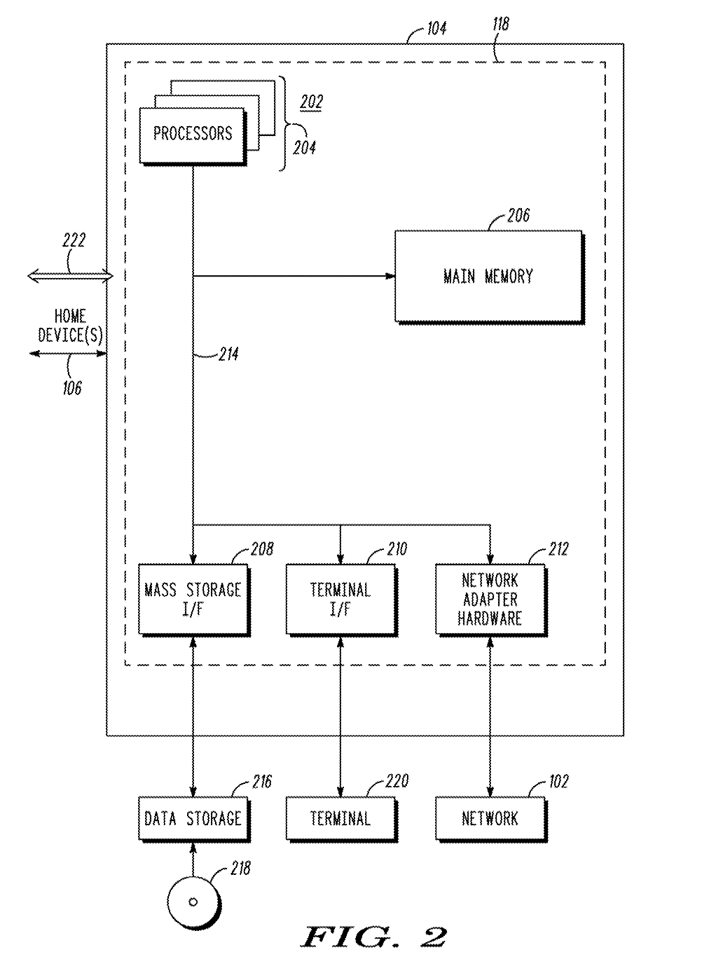

FIG. 2 is a block diagram illustrating a general architecture for an information processing system such as the central processing system 104. The central processing system 104 is based upon a suitably configured processing system adapted to implement the exemplary embodiment of the present invention. Any suitably configured processing system is similarly able to be used as the information processing system 104 by embodiments of the present invention, for example, a personal computer, workstation, or the like.

The central processing system 104 includes the home client device manager 118. The home client device manager 118 includes a computer 202. The computer 202 has a set of processors 204, which can include one or more processors. The set of processors are communicatively coupled to a main memory 206 (e.g., volatile memory), mass storage interface 208, a terminal interface 210, and network adapter hardware 212. A system bus 214 interconnects these system components. It should be noted that in one embodiment, the set of processors 204 operate in an SMP computing environment, where parallel applications can have several tasks (processes) that execute on the various processors. In one embodiment, the set of processors 204 create a processing cluster.

The mass storage interface 208 is used to connect mass storage devices, such as data storage device 216 to the central processing system 104. One specific type of data storage device is a computer readable medium such as a CD drive, which may be used to store data to and read data from a CD 218 or DVD or floppy diskette (not shown). Another type of data storage device is a data storage device configured to support, for example, fixed disk type file system operations. In one embodiment, the central processing system 104 utilizes conventional virtual addressing mechanisms to allow programs to behave as if they have access to a large, single storage entity, referred to herein as a computer system memory, instead of access to multiple, smaller storage entities such as the main memory 206 and data storage device 216. Note that the term “computer system memory” is used herein to generically refer to the entire virtual memory of the central processing system 104

Although only one CPU 204 is illustrated for computer 202, computer systems with multiple CPUs can be used equally effectively. Some embodiments of the present invention further incorporate interfaces that each includes separate, fully programmed microprocessors that are used to off-load processing from the CPU 204. Terminal interface 210 is used by some embodiments to directly connect one or more terminals 220 to computer 202 to provide a user interface to the computer 202. These terminals 220, which are able to be non-intelligent or fully programmable workstations, are used to allow system administrators and users to communicate with the central processing system 104. The terminal 220 is also able to comprise user interface and peripheral devices that are connected to computer 202 and controlled by terminal interface hardware included in the terminal I/F 210 that includes video adapters and interfaces for keyboards, pointing devices, and the like.

An operating system (not shown), according to an embodiment, can be included in the main memory 206 and is a suitable multitasking operating system such as the Linux, UNIX, Windows XP, and Windows Server operating system. Embodiments of the present invention are able to use any other suitable operating system, or kernel, or other suitable control software. Some embodiments of the present invention utilize architectures, such as an object oriented framework mechanism, that allows instructions of the components of operating system (not shown) to be executed on any processor located within the client. The network adapter hardware 212 is used to provide an interface to the network 102. Embodiments of the present invention are able to be adapted to work with any data communications connections including present day analog and/or digital techniques or via a future networking mechanism.

The various resources discussed above such as the set of processors 204, the main memory 206, data storage 216, and the like are shared by one or more of the home client devices coupled to the central processing system 104. For example, a processor within the set of processors 204 can be an audio/video codec processor. An A/V stream 222 received by the central processing system 104 can be decoded and processed by this processor and the resulting signal can be passed to the home client device via the network adapter hardware 212. The data storage 216, in one example, can be used for storing recorded multimedia content requested by a home client device. The various functions of the central processing system 104 is discussed in greater detail below.

Although the exemplary embodiments of the present invention are described in the context of a fully functional computer system, those skilled in the art will appreciate that embodiments are capable of being distributed as a program product via floppy disk, e.g. floppy disk, CD-ROM 218, or other form of recordable media, or via any type of electronic transmission mechanism.

Home Client Devices

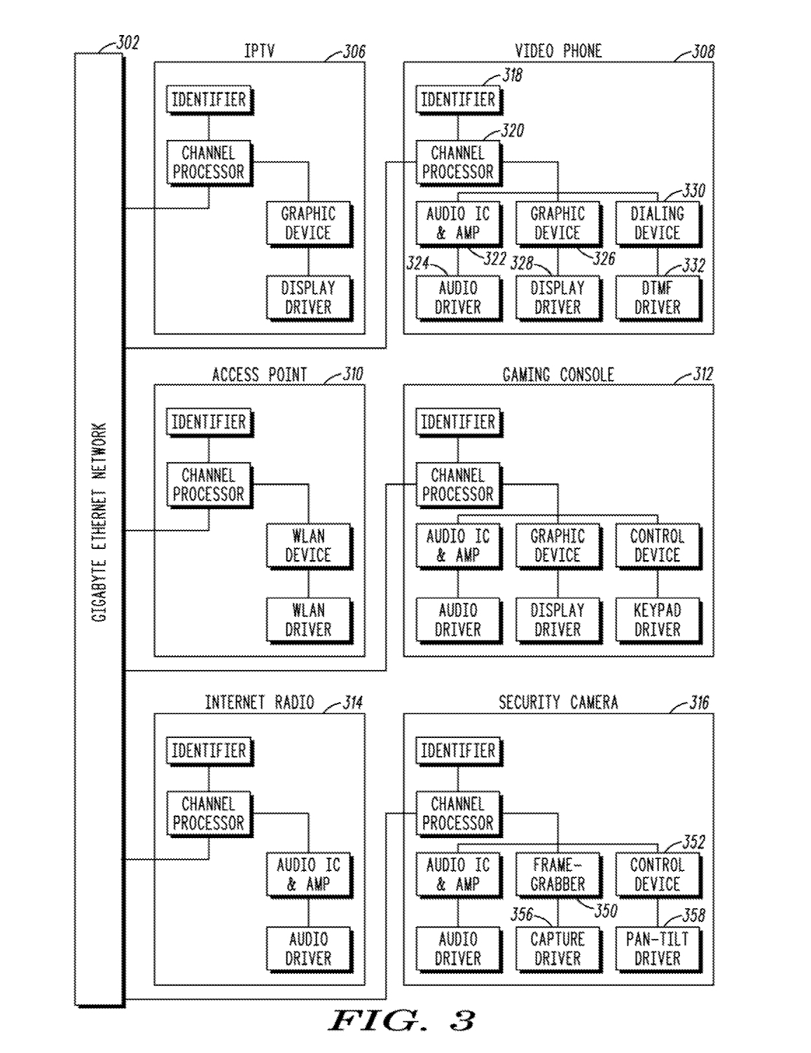

FIG. 3 is a block diagram showing exemplary home client devices in greater detail. It should be noted that the home client devices of FIG. 3 are only illustrative and do not limit the present invention in any way. FIG. 3 shows home client devices such as an IPTV device 306, a video phone 308, an access point 310, a gaming console 312, an Internet radio 314, and a security camera 316.

Each home client device includes an identifier module 318 and a channel processor 320. The identifier module 318, in one embodiment, accepts user inputs, requests, and the like and includes an identifier that uniquely identifies the respective home client device. The identifier stored within the identifier module 318 is a unique identifier that not only uniquely identifies the respective home client device, but also identifies the function of that respective home client device. In one embodiment, the identifier identifies that a device is, for example, an IPTV device, a video phone device, or any other type of device supportable by the particular embodiment. This identifier is able to be encoded with information that specifies the type of processing, including hardware processing and software processing, that is available to the device, such as processing to support IPTV, video phone service, and the like. Based on the function specified by the identifier, the central processing system is able to access and operate with a service profile to reflect, among other things, the function of the home client device being supported. The identifier of some embodiments specifies configuration information associated with at least one of hardware processing and software processing available to the home client device.

As an example of accepting user input, using the video phone 308 as a particular example, user inputs may be digits of a phone number, contact list lookup, and the like. A user request may be to initiate a video call with audio to another party. The identifier module 318 accepts these inputs/requests and transmits them to the central processing system 104 along with a unique identifier. The unique identifier allows the central processing system 104 to identify a specific home client device from the group of home client devices.

The following discussion describes the components and operation of a video phone 308 as an example of home client devices. The other home client devices include components similar to those described below to support operation with a centralized processing system. Other home client devices are also able to include processing components that are familiar, in light of the present discussion, to ordinary practitioners of the relevant arts.

The channel processor 320 manages the communication between the respective home client device and the central processing system 104. For example, each home client device may have a separate communication path established between the home client device and the central processing system 104. In another embodiment, two or more home client devices can share a communication path. In this embodiment, the channel processors 320 of each home client device manage the shared communication path.

As discussed above, the home client devices, in one embodiment are thin client home client devices. In other words, dedicated processing is not performed on the home client devices. The central processing system 104 performs the dedicated processing. This allows for processing capabilities to be centrally located and centrally managed by a single system, which allows for a more scalable processing environment. The home client devices of some embodiments only include the necessary hardware and/or software to, for example, accept user input, display video, produce audio, and communicate/receive data to/from the central processing system. For example, the video phone 308, in this embodiment, only includes an audio IC/AMP 322, audio driver 324, graphic device 326, display driver 328, dialing device 330, and DTMF driver 332. As can be seen, dedicated processing hardware is not included within the videophone 308. Any hardware required for processing audio, video, inputs, received data, and the like resides on the central processing system 104.

Various embodiments of the present invention are alternatively able to incorporate software based processors, dedicated processing hardware, or a combination of software and dedicated hardware processors into the central processing system 104 in order to support the home client devices. Such processors are not required, in some embodiment, to be provided within the home client device. For example, the video phone 308 may have a touch screen used for dialing. The software for generating the on-screen dialing pad can reside on the central processing system 104. The video phone 308 only needs to have a driver and hardware to display the on-screen dialing pad to a user. Each of the home client devices are connected to a network as discussed above. FIG. 3 shows the home client devices as being connected to a Gigabyte Ethernet network 302. The network 302 enables the home client devices to communication with the central processing system 104 and each other.

The various home client devices are also able to include specialized processing hardware to support their particular function. For example, a security camera 316 is able to include a frame-grabber 350 and control device 352, which are controlled by a capture driver 356 and pan-tilt driver 358, respectively. In this example, the frame-grabber 350 is used to capture a video image and the control device 352 is used to control the position of the security camera 316. The processing resources of the central processing system 104 are also used in conjunction with the components of the security camera 316 to provide a more cost effective and easily maintained home client device.

Central Processing System

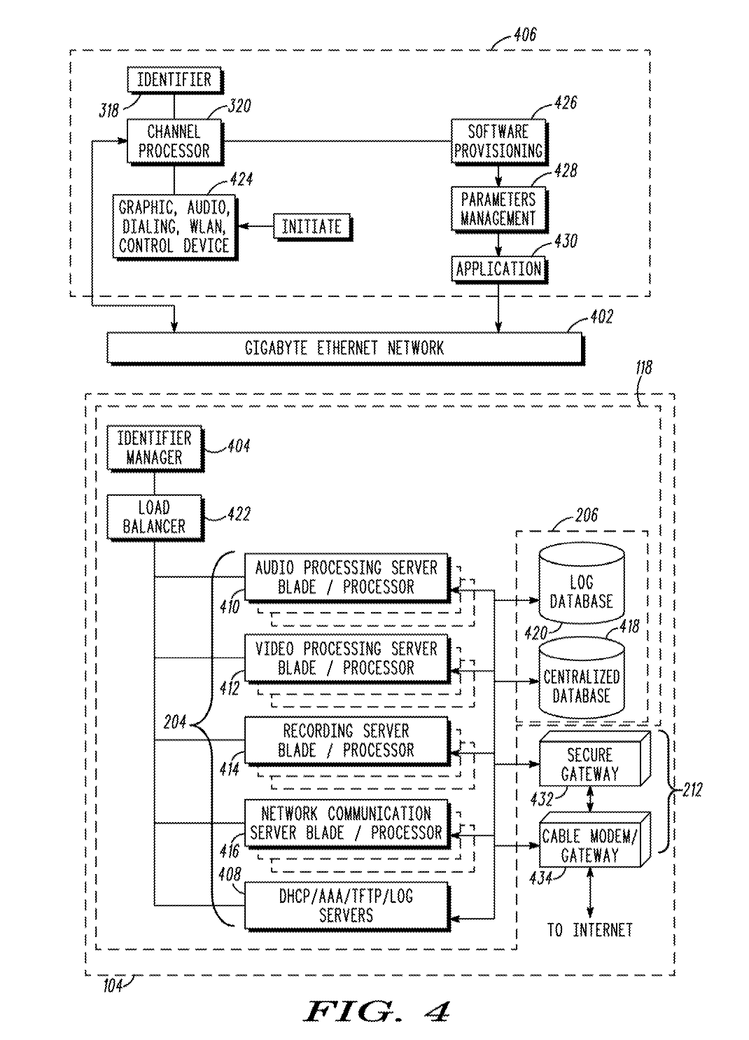

FIG. 4 is a block diagram illustrating a more detailed view of the central processing system 104 according to an embodiment of the present invention. FIG. 4 shows the central processing system 104 communicatively coupled to a home client device 406 via a network 402 such as a Gigabyte Ethernet network. As discussed above, the central processing system 104 includes a home client device management module 118. The home client device management module 118 provides requested resources to each of the home client devices. The home client device management module 118, in one embodiment, includes an identifier manager 404, a load balancer 422, the set of processors 204, the memory system 206, and network hardware/software 212.

The identifier manager 404 receives home client device requests, inputs, identifying information, and the like. The identifier manager 404 of some embodiments of the present invention receives from each home client device a unique identifier that identifies the functions performed by that device. The identifier manager 404, in one embodiment, further performs security access and authentication operations based on identifying information received from the home client device. For example, the identifier manager 404 determines if a home client device has rights to access the processing and/or data resources of the central processing system 104. The central processing system 104 can also maintain user or administrator defined policies. For example, user of a home client device may want certain parameters configured for a home client device such as a recording schedule, specific audio codecs/video codecs, and the like. These parameters/policies can be stored within the memory system 206. Additionally, security policies can be associated with a home client device such as resource access, bandwidth usage, and the like. The identifier manager 404 accesses these policies when a home client device communicates with the central processing system 104. In another embodiment, a processor such as an authentication processor 408 within the processor set 204 can perform the above authorization procedures. Security processing performed by some embodiments of the present invention further includes limiting access to media stored or accessed by the central processing system 104.

The identifier manager 404, in one embodiment, also provides fast channel switching and connection to the intended processor(s) in the processor set 204. Fast Channel Switching allows the central processing system 104 to re-use any previous resources (bandwidth, processor, network settings and the like) assigned to the home client device before its timer expiration. Also, the network information from the access of another home client device can be re-used by other home client devices. This eliminates the need to re-compute and rebuild network switching tables. The timer expiration is included in the service profile. The home client device management module 118 also includes a load balancer 422. The load balancer 422 is a management system for each processor in the processor set 206. The load balancer 422 optimizes the power/computation consumption when more processing capability is required. The load balancer 422 symmetrically distributes the load on assigned processors. One advantage of the load balancer 422 is that general processors can be utilized by any home device applications as compared to specialized processors for dedicated applications. This provides scalability and interoperability to the processors in the processor set 206 to allow efficient processing support for multiple home client devices. The user or administrator defined policies above can also define the number of processors used for load balancing for a particular home client device.

The memory system 206, in one embodiment, is a dedicated memory system that is utilized by the home client devices. In some embodiments, a memory system 206 that includes a centralized memory database 418 and a log database 420 replaces the dedicated memory on the home client devices. The log database maintains a record of home client device resource utilization, requests, software updates, and the like. A log database 420, in one embodiment, also records any abnormal or error events, that have occurred between interconnected home client devices, the central processing system 104 and the internet connection. This log database 420 can be accessed remotely by technicians to help troubleshoot and maintain the central processing system 104. A centralized database 418 can also be used to record or store any media and data information from the home client devices. The media and data information can be played back locally at any interconnected home client devices or be sent to other remote network devices.

The centralized memory database 418, in one embodiment, comprises available memory that is used by the processor set 204 when processing data for a home client device. The centralized memory database 418 can also include software applications for supporting and performing required functions of the home client devices. For example, if a home client device is a set-top recorder, the recording software, GUIs, and the like can be maintained in the centralized database. Therefore, in addition to maintaining processing resources for the home client devices, the centralized server can also maintain software resources for the home client devices. One advantage of a centralized memory system 206 is that the home client devices are no longer constrained by the embedded memory of each home device.

The processor set 206 comprises a plurality of processors 408. For example, FIG. 4 shows an audio processing server blade/processor 410, a video processing server blade/processor 412, a recording server blade/processor 414, a network communication serer blade/processor 416, a DHCP/AAA/TFTP/log server, and the like. Each of these processing blades can be utilized by the home client devices. These processors perform the dedicated processing required by a home client device. For example, FIG. 4 shows a home client device 406, which only includes the minimum amount of hardware/software to, for example, receive user input, send/receive information to/from the central processing system 104, present information to a user, and manage the information. For example, the home client device 406 includes the identifier module 308, channel processor 320, drivers and various user interaction hardware (e.g., display, keypad, etc.) 424, a software provisioning module 426, parameters management module 428, and applications 430. As can be seen, dedicated memory and processors are not necessarily included on the home client device. Also, applications 430 can also reside on the central processing system 104 and not the home client device 406.

The processor set 206 on the central processing system 104, performs the required processing operations that are normally performed on a home client device. For example, the home client device 406 of some embodiments can be a cable set-top box. However, the tuner used for decoding audio and video does not reside on the home client device 406, but instead resides within the central processing system 104. The central processing system 104 can receive user input such as what channel is desired, what channels are to be recorded, video/audio playback functions, and the like. The central processing system 104 can then communicate with the content provider via the network hardware 212 to receive the content desired by the user. In one embodiment, the network hardware 212 includes a secure gateway 432 and a cable modem/gateway 434. The audio and video processors 410, 412 in the processor set 206 process the content to decode the signal and pass the decoded signal to the home client device. The home client device can then pass the decoded signal to a display.

Therefore, the present invention eliminates the need for dedicated processors such as audio/video codec processors to be embedded within home client devices. The present invention combines these processors within a centrally located multiprocessor system. The present invention provides load balancing to optimize power/computation consumption and also eliminates the need for dedicated memory to be embedded within the home client device. For example, the present invention includes a central memory system that can be shared by each home client device coupled to the central processing system 104. By centrally locating a memory system the home client devices are no longer constrained by their limited memory resources. The present invention also allows for the scalability of processors, which maximizes the cost investment of the home client devices. Additional processors can be added to the central processing system to provide new functions and processing power to the home client devices. Also, obsolescence of the home client devices can be prevented by adding new software and/or updating the software residing in the central processing system 104.

Process of Requesting a Service/Content from Central Processing System

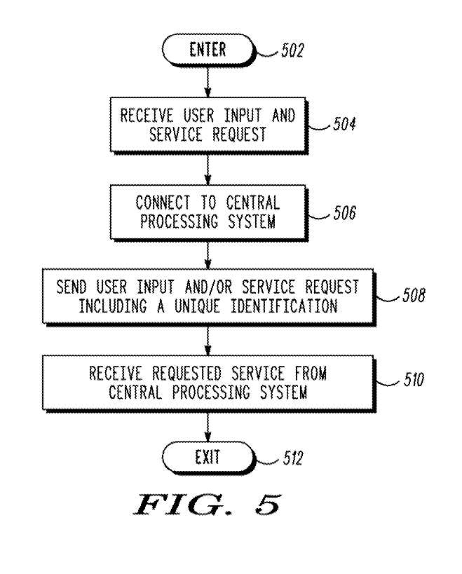

FIG. 5 illustrates a process of a home client device requesting a service and/or content from the central processing system 104. The operational flow diagram of FIG. 5 begins at step 502 and flows directly to step 504. The home client device, at step 504, receives user input and/or a service request. For example, if the home client device is a cable set-top box, the user input can be a channel selection for requesting a specific movie. The home client device, at step 506, connects to the central processing system 104. The requested service and/or user input, at step 508, is sent to the central processing system 104 along with a unique identifier. The unique identifier signifies the type of home client device sending the request. The home client device, 510, receives the requested content/ service in a processed form. For example, the central processing system 104 can retrieve the request audio/video content from a service provider and process the signal. This processed signal is then received by the home client device. Therefore, the home client device does not have to perform decoding or any other processing of the signal. The control flow then exits at step 512.

Process of Providing a Requested Service/Content to a Home Client Device

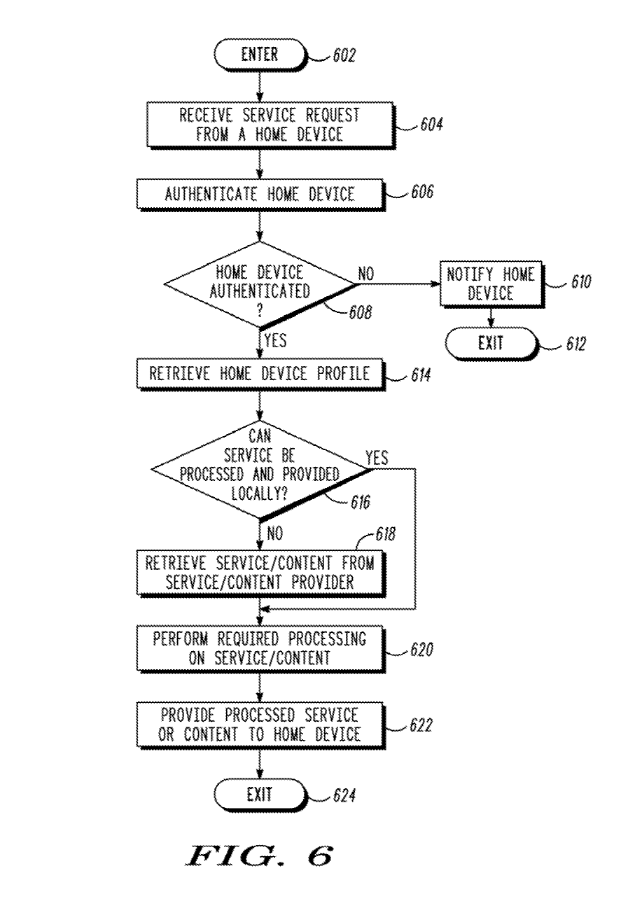

FIG. 6 illustrates a process of central processing system 104 providing a requested service/content to a home client device. The operational flow diagram of FIG. 6 begins at step 602 and flows directly to step 604. The central processing system 104, at step 604, receives a request for a service and/or content from a home client device. The central processing system 104, at step 606, authenticates the home client device. For example, the request for content can include an identifier that uniquely identifies the home client device and further identifies the type of device, such as video phone 308, gaming console 312, or other device supported by the central processing system 104. The central processing system 104 can determine if a device profile exists for the home client device based on the identifier.

The central processing system 104, at step 608, determines if the home client device is authenticated/authorized. If the result of this determination is negative, the central processing system 104, at step 610, notifies the home client device that it is not authenticated/authorized. The control flow then exits at step 612. If the result this determination is positive, the central processing system 104, at step 614, retrieves a device profile to determine the services/content associated with the device, any parameters/configurations associated with the device, and the like. The central processing system 104, at step 615, determines the processing required to support the service requested by the at least one thin client home device based on the at least one request. The central processing system 104, at step 616, determines if the requested service or content can be provided by the processing system locally.

For example, the home client device may be requesting recorded content that is stored in the memory system 206. Therefore, the content can be provided locally. The home client device may also be requesting to record a television program. Therefore, the central processing system 104 can also provide this service locally. However, the home client device may be requesting to receive a television program that is not stored on the central processing system 104. For example, the home client device can be requesting a device from a cable service provider. Therefore, this service cannot be provided locally.

If the result of the determination at step 616 is positive, the control flows to step 619. If the result of this determination is negative, the central processing system 104, at step 618, retrieves the service/content from the service/content provider. For example, the central processing system 104 can query a cable service provider for the request movie, channel, or the like. The central processing system 104, at step 619, selects at least one processor from a set of processors to perform the processing based upon the processing required to support the service. The central processing system 104, at step 620 performs the required processing on the service/content. For example, the central processing system 104 can perform audio/video processing, GUI generating, and the like to produce, for example, processed data representative of the requested service and/or content. The processed service/content, at step 622, is then provided to the home client device, which does not have to perform the processing normally required at a home client device. The control flow then exits at step 624.

A More Detailed Process of Providing a Home Client Device Requested Services/Content

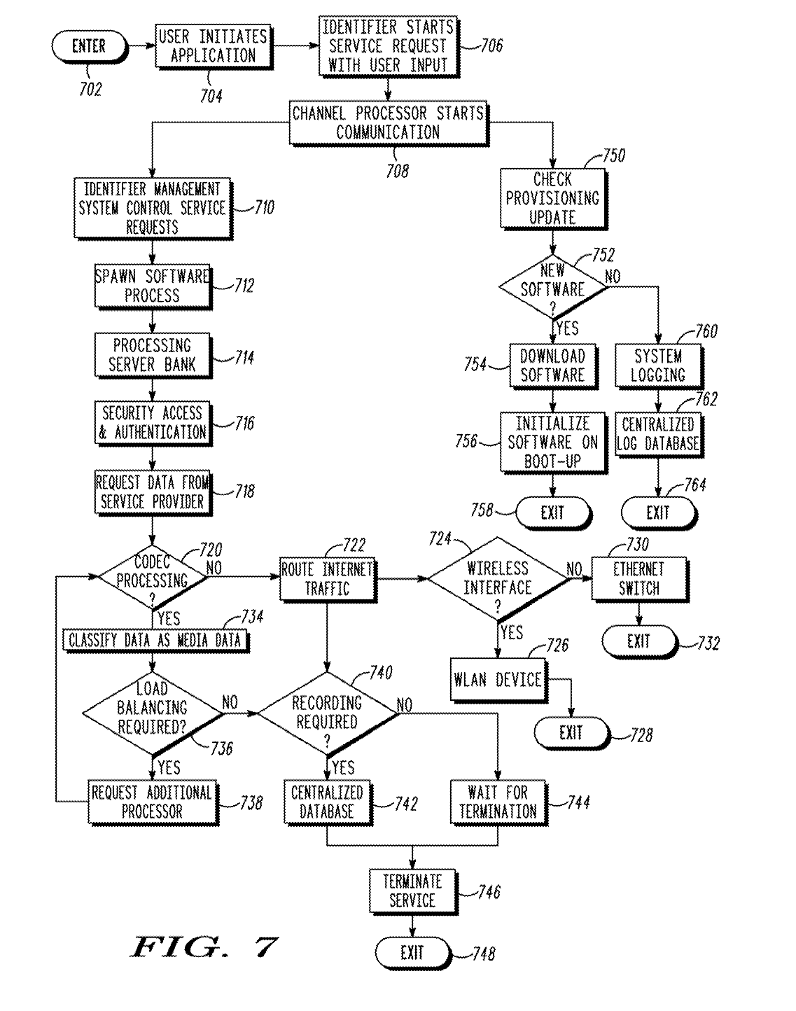

FIG. 7 illustrates a more detailed process of providing a home client device a requested service and/or content. The operational flow diagram of FIG. 7 begins at step 702 and flows directly to step 704. A user, at step 704, initiates an application to request a service on the home client device. For example, the user can click a button, use a voice command, or the like. An identifier 318, at step 706, in the home client device constructs and packetizes the service request. The channel processor 320, at step 708, starts the authentication and communication process with the central processing system 104.

Once the central processing system 104 receives the service request the central processing system 104, at step 710, retrieves the home client device profile. It also controls the resources assigned for the service request. A software process, at step 712, is spawned for the type of service requested and the processor performance baseline is estimated. The software process, at step 714, requests the resources from the processing server bank and starts running the process. If the request requires the content/service from a remote service/content provider, the security access and authentication procedure, at step 716, creates a secure connection. The central processing system 104, at step 718, requests data from the service/content provider. The central processing system 104, at step 720, determines if codec processing is required on the data received from the service/content provider. If the result of this determination is negative, then the data, at step 722, is classified as an internet data and is routed together with the internet traffic.

The central processing system 104, at step 724, determines if the home client device that requested the data is using Wireless LAN connectivity. If the result of this determination is positive, the data, at step 726, is routed to the wireless Access Point. The control flow then exits at step 728. If the result of this determination is negative, then the data, at step 730 is forwarded to the Ethernet switch. The control flow then exits at step 732. Returning to step 720, if the result of this determination is positive, then the data, at step 734, is classified as a media data. The load balancer 422, at step 736, determines if the computational resources allocated from the processing server bank 204 are sufficient to maintain QoS and performance.

If the result of this determination is negative, the load balancer, at step 738, requests additional processor from the processing server bank 204. This procedure is repeated until the load balancer 422 determines that the media data can be sufficiently processed for QoS and performance and then streamed to the requesting home client device. The central processing system 104, at step 740, determines if recording is required on the media data. If the result of this determination is positive, the media, at step 742, is stored in the centralized database 418 until the service is terminated. If the result of this determination is negative, the service, at step 744, waits for termination. The service, at step 746, is terminated and the control flow then exits at step 748.

Returning back to step 708, after a channel processor 322 is authenticated and starts communication, the central processing system, at step 750, checks for provisioning updates for the home client device based on its Identifier information. The central processing system 104, at step 752, determines if there is new software. If the result of this determination is positive, (e.g., new software (including OS, firmware, drivers, patches, and the like) is available for the home client device), the central processing system 104, at step 754, requests to download the software from its remote site and the software is downloaded to the centralized database 418. The software waits for any ongoing service on the home client device to be terminated. Upon the termination of the service, the software is downloaded to the home client device via tftp, ftp or any file transfer method. After successful download of the new software, the home client device, at step 756, is rebooted. The new software is initialized on boot-up. The control flow then exits at step 758. If the result of the determination at step 752 is negative, then the system logging of resource utilization, requests, software updates, events and the like, at step 760, is performed and recorded in the log database 420 at step 762. The control flow then exits at step 764.

Non-Limiting Examples

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for providing services to a thin client home device, the method comprising:
receiving, at an information processing system through a local area network from at least one thin client home device, at least one request for a service, wherein the information processing system and the at least one thin client home device are both connected to the local area network;
determining that processing required by the service can be provided locally;
selecting, in response to determining that the processing can be provided locally, at least one local processor from a set of local processors to perform the processing required to support the service and to produce processed data;
selecting, in response to determining that the processing cannot be provided locally, at least one remote processor from a set of remote processors to perform the processing required to support the service and to produce processed data; and
transmitting, through the local area network, the processed data to the at least one thin client home device.

2. The method of claim 1, further comprising:
identifying, in response to determining that the service cannot be provided locally, a remote service provider associated with the requested service; and
requesting, in response to determining that the service cannot be provided locally, data for the service from the remote service provider, wherein the at least one remote processor processes the data to produce the processed data.

3. The method of claim 1, further comprising:
determining that load balancing is required to perform the processing;
selecting, in response to determining that load balancing is required, at least one additional processor from the set of processors; and
processing data associated with the requested service via the selected processor and the at least one additional processor in response to determining that load balancing is required.

4. The method of claim 1, wherein the local area network is adapted to communicate data between the information processing system and the at least one thin client home device via fast channel switching.

5. The method of claim 1, further comprising:
receiving, from the at least one thin client home device, device configuration information including at least configuration information associated with at least one of hardware processing and software processing available to the at least one thin client home device.

6. The method of claim 1, further comprising:
determining a service profile associated with the at least one thin client home device, wherein the service profile comprises services available to the thin client home device and wherein the processing is performed based at least in part upon the service profile.

7. The method of claim 6, where the determining comprises:
receiving, from the at least one thin client thin client home device, a unique identifier that identifies a function associated with the at least one thin client home device; and
retrieving the service profile associated with at least one thin client thin client home device based on the unique identifier.

8. An information processing system for providing services to a thin client home device, the information processing system comprising:
a memory;
a processor communicatively coupled to the memory;
a local area network interface adapted to communicate data with at least one thin client home device through a local area network that is connected to both the local area network interface and to the at least one thin client home device; and
a home client device management module, communicatively coupled to the memory, the processor, and the local area network interface, wherein the home client device management module is adapted to:
receiving, through the local area network from the at least one thin client home device, at least one request for a service;
determining that processing required by the service can be provided locally;
selecting, in response to determining that the processing can be provided locally, at least one local processor from a set of local processors to perform the processing required to support the service and to produce processed data;
selecting, in response to determining that the processing cannot be provided locally, at least one remote processor from a set of remote processors to perform the processing required to support the service and to produce processed data; and
transmitting the processed data to the at least one thin client home device through a local area network.

9. The information processing system of claim 8, wherein the home client device management module is further adapted to:
identifying, in response to determining that the service cannot be provided locally, a remote service provider associated with the requested service; and
requesting, in response to determining that the service cannot be provided locally, data for the service from the remote service provider, wherein the at least one remote processor processes the data to produce the processed data.

10. The information processing system of claim 8, wherein the home client device management module is further adapted to:
determining that load balancing is required to perform the processing;
selecting, in response to determining that load balancing is required, at least one additional processor from the set of processors; and
processing data associated with the requested service via the selected processor and the at least one additional processor in response to determining that load balancing is required.

11. The information processing system of claim 8, wherein the local area network is adapted to communicate data with between the local area network interface and the at least one thin client home device via fast channel switching.

12. The information processing system of claim 8, wherein the home client device management module is further adapted to:
receiving, from the at least one thin client home device, device configuration information including at least configuration information associated with at least one of hardware processing and software processing available to the at least one thin client home device.

13. The information processing system of claim 8, wherein the home client device management module is further adapted to:
determining a service profile associated with the at least one thin client home device, wherein the service profile comprises services available to the thin client home device and wherein the processing is performed based at least in part upon the service profile.

14. The information processing system of claim 13, where the determining comprises:
receiving, from the at least one thin client thin client home device, a unique identifier that identifies a function associated with the at least one thin client home device; and
retrieving the service profile associated with at least one thin client thin client home device based on the unique identifier.

15. A computing environment for providing services to a thin client home device, the computing environment comprising:
at least one thin client home device;
a local area network connected to the at least one thin client home device;
a centralized processing system connected to the local area network and communicatively coupled to the thin client home device through the local area network, wherein the centralized processing system includes a home client device management module, and wherein the home client device management module is adapted to:
receiving, from at least one thin client home device through the local area network, at least one request for a service;
determining, based on the at least one request, processing required to support the service requested by the at least one thin client home device;
determining that the processing can be provided locally;
selecting, in response to determining that the processing can be provided locally, at least one local processor from a set of local processors to perform the processing required to support the service and to produce processed data;
selecting, in response to determining that the processing cannot be provided locally, at least one remote processor from a set of remote processors to perform the processing based upon the processing required to support the service and to produce processed data; and
transmitting the processed data to the at least one thin client home device through the local area network.

16. The computing environment of claim 15, wherein the home client device management module is further adapted to:
identifying, in response to determining that the service cannot be provided locally, a remote service provider associated with the requested service; and
requesting, in response to determining that the service cannot be provided locally, data for the service from the remote service provider, wherein the at least one remote processor processes the data to produce the processed data.

17. The computing environment of claim 15, wherein the home client device management module is further adapted to:
determining that load balancing is required to perform the processing;
selecting, in response to determining that load balancing is required, at least one additional processor from the set of processors; and
processing data associated with the requested service via the selected processor and the at least one additional processor, in response to determining that load balancing is required.

18. The computing environment of claim 15, wherein the local area network is adapted to communicate data with between the centralized processing system and the at least one thin client home device via fast channel switching.

19. The computing environment of claim 15, wherein the home client device management module is further adapted to:
receiving, from the at least one thin client home device, device configuration information including at least configuration information associated with at least one of hardware processing and software processing available to the at least one thin client home device.

20. The computing environment of claim 15, wherein the home client device management module is further adapted to:
determining a service profile associated with the at least one thin client home device, wherein the service profile comprises services available to the thin client home device and wherein the processing is performed based at least in part upon the service profile;
receiving, from the at least one thin client thin client home device, a unique identifier that identifies a function associated with the at least one thin client home device; and
retrieving the service profile associated with at least one thin client thin client home device based on the unique identifier.
